(19) United States
(12) Patent Application Publication
(10) Pub. No.: US 2026/0059120 A1
(43) Pub. Date: Feb. 26, 2026

(54) GEOMETRIC PARTITION MODE BOUNDARY PREDICTION

(71) Applicant: INTERDIGITAL CE PATENT HOLDINGS, SAS, Paris (FR)

(72) Inventors: Franck GALPIN, Thorigne-Fouillard (FR); Philippe BORDES, Laille (FR); Antoine ROBERT, Mézières sur Couesnon (FR); Karam NASER, Mouazé (FR)

(21) Appl. No.: 19/103,258

(22) PCT Filed: Jul. 28, 2023
(86) PCT No.: PCT/EP2023/070978

§ 371 Date: Feb. 12, 2025

(30) Foreign Application Priority Data
Aug. 12, 2022 (EP) 22306218.3

(51) Int. Cl. H04N 19/176; H04N 19/119; H04N 19/157; H04N 19/70

(52) U.S. Cl. CPC H04N 19/176; H04N 19/119; H04N 19/157; H04N 19/70

(57) ABSTRACT

Prediction of a boundary used in geometric prediction modes is accomplished with embodiments that remove a requirement of reconstruction of samples of the current block, which increases pipeline latency. In one embodiment, the best boundary is predicted and added as a candidate to a list. In another embodiment, the candidates are ranked according to their boundary fitting score and an index is signaled to select the correct candidate at a corresponding decoder. In another embodiment, the fitting of the boundary is computed using a metric along the boundary sub-block. In another embodiment, the fitting of the boundary is computed using a metric outside the boundary area.

### CROSS REFERENCE TO RELATED APPLICATION

This application claims the benefit of European Application Serial No. 22306218.3, filed Aug. 12, 2022, which is incorporated by reference herein in its entirety.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for predicting a boundary when using geometric partitions (GEO) when using geometric partitioning mode (GPM), in coding standards, such as the VVC (Versatile Video Coding or H.266) standard.

According to a first aspect, there is provided a method. The method comprises steps for determining one or more boundary candidates within a video block that uses geometric partitioning mode; associating the one or more boundary candidates with metrics to determine which boundary candidate to use for encoding; encoding said video block in geometric partitioning mode using the determined boundary candidate and prediction modes corresponding to portions of the video block defined by the determined boundary candidate; and, signaling the determined boundary candidate used in geometric partitioning mode

According to a second aspect, there is provided another method. The method comprises steps for determining a boundary within a video block that uses geometric partitioning mode from a list of two or more boundary candidates; and, decoding said video block using prediction modes corresponding to portions of the video block defined by the boundary.

According to another aspect, there is provided an apparatus. The apparatus comprises a processor. The processor can be configured to encode a block of a video or decode video data by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, video data or a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates an example geometric split description.

FIG. 2 illustrates geometric partition with angle 12 and distance between 0 and 3.

FIG. 3 illustrates angles proposed for GEO with their corresponding width:height ratio

FIG. 4 illustrates uni-prediction motion vector selection for GEO partition mode.

FIG. 5 illustrates MMVD signaled as pair of distance and direction.

FIG. 6 illustrates GPM with inter and intra prediction with available IPM candidates ((a)-(c)) and an example (d) of GPM with intra and intra prediction.

FIG. 7 illustrates an example of a boundary edge on templates.

FIG. 8 illustrates an example GPM split boundary.

FIG. 9 illustrates an example of weighting per samples.

FIG. 10 illustrates differential coding of a boundary position.

FIG. 11 illustrates an example of intra inter GPM mode.

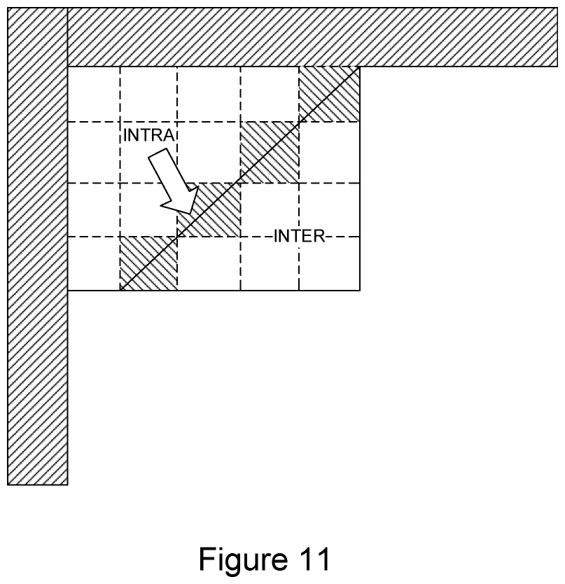

FIG. 12 illustrates a standard, generic, video compression scheme.

FIG. 13 illustrates a standard, generic, video decompression scheme.

FIG. 14 illustrates a processor-based system for encoding/decoding under the general described aspects.

FIG. 15 illustrates one embodiment of a method under the described aspects.

FIG. 16 illustrates a second embodiment of a method under the described aspects.

FIG. 17 illustrates one embodiment of an apparatus under the described aspects.

### DETAILED DESCRIPTION

The embodiments described here are in the field of video compression and generally relate to video compression and video encoding and decoding more specifically aims at improving compression efficiency compared to existing video coding systems.

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

In the HEVC (High Efficiency Video Coding) video compression standard, motion compensated temporal prediction is employed to exploit the redundancy that exists between successive pictures of a video.

To do, a motion vector is associated to each prediction unit (PU), which is introduced now. Each CTU (Coding Tree Unit) is represented by a Coding Tree in the compressed domain. This is a quad-tree division of the CTU, where each leaf is called a Coding Unit (CU).

Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level.

Exactly one Motion Vector is assigned to each PU in HEVC. This motion vector is used for motion compensated temporal prediction of the considered PU.

In the Versatile Video Codec (VVC) developed by the JVET (Joint Video Exploration Team) group, a CU is no more divided into PU or TU, and some motion data is directly assigned to each CU. In this new codec design, a CU can be divided into sub-CU with a motion vector computed for each sub-CU.

### Geometric Merge Mode

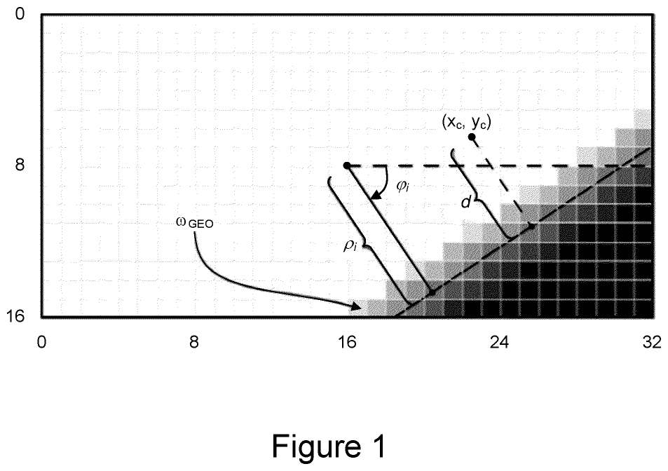

In VVC, a geometric merge mode (GEO) is supported with 32 angles and 5 distances. The angle φᵢ is quantized from between 0 and 360 degrees with a step equal to 11.25 degree for a total of 32 angles. The description of a geometric split with angle φᵢ and distance ρᵢ is depicted in FIG. 1.

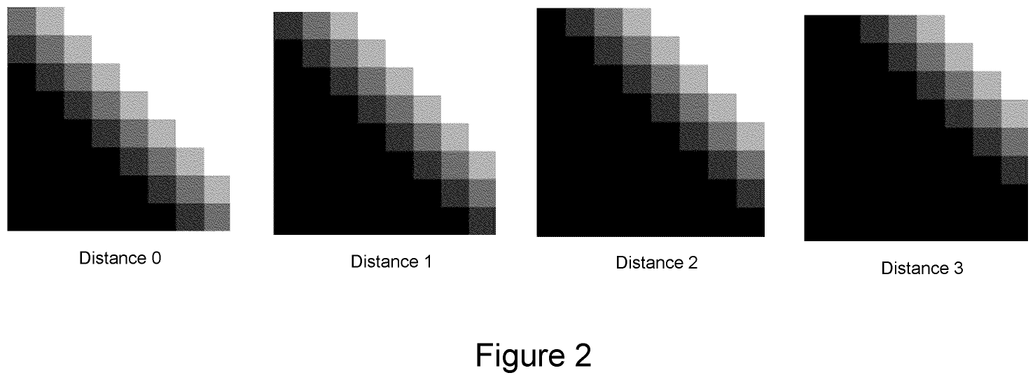

Distance ρᵢ is quantized from the largest possible distance ρₘₐₓ with a fixed step, it indicates a distance from the center of the block. For distance ρᵢ=0, only the first half of the angles are available as splits are symmetric in this case. For example, the results of geometric partitioning using angle 12 and distance between 0 to 3 is depicted in FIG. 2.

For a distance ρᵢ equal to 0, symmetrical angles 16 to 31 are removed because they correspond to same splits as 0-15. Angles 0 and 8 are also excluded because they are similar to binary split of CUs, leaving only 14 angles for distance 0. So, a maximum of 142 split modes may be used by geometric partitioning (14+32*4=142).

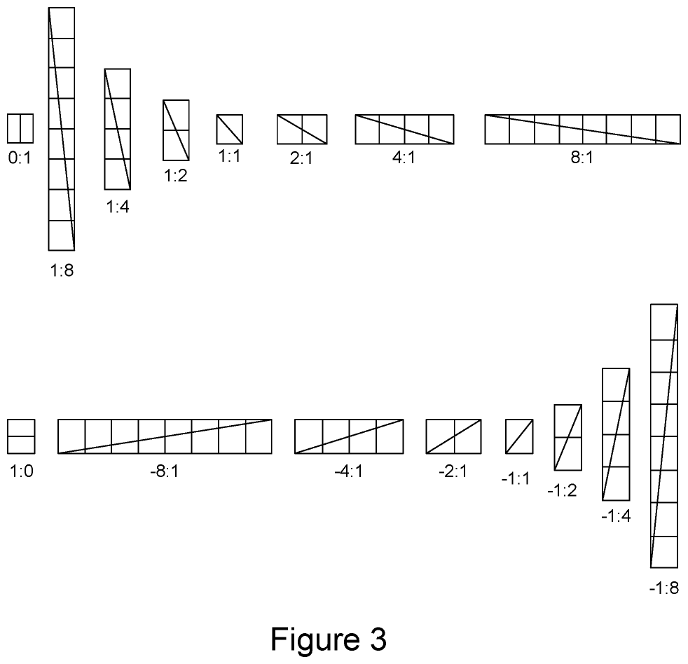

To simplify the GEO partitioning process, the angles in GEO are replaced with the angles which have powers of 2 as tangent. Since the tangent of the proposed angles is a power-of-2 number, most of multiplications can be replaced by bit-shifting. With the proposed angles, one row or column is needed to store per block size and per partition mode, as depicted in FIG. 3.

### Uni-Prediction Candidate List Construction for GEO

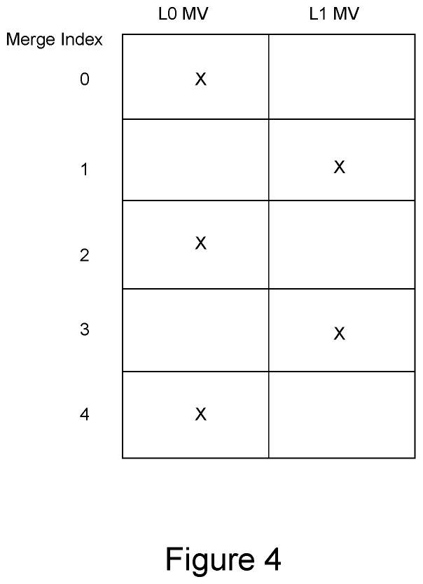

The GEO uni-prediction candidate list is derived directly from the merge candidate list constructed according to the extended merge prediction process. Denote n as the index of the uni-prediction motion in the GEO uni-prediction candidate list. The LX motion vector of the n-th extended merge candidate, with X equal to the parity of n, is used as the n-th uni-prediction motion vector for GEO partition mode. These motion vectors are marked with “x” in FIG. 4. In case a corresponding LX motion vector of the n-th extended merge candidate does not exist, the L (1-X) motion vector of the same candidate is used instead as the uni-prediction motion vector for GEO partition mode.

There are up to 5 uni-prediction candidates and an encoder has to test all the combinations of candidates (one for each partition) with the splitting directions and offsets.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge depending on the angle φᵢ and distance ρᵢ as depicted in the example of FIG. 2.

### Motion Field Storage for Geometric Partitioning Mode

MV1 from the first part of the geometric partition, Mv2 from the second part of the geometric partition and a combined Mv of Mv1 and Mv2 are stored in the motion field of a geometric partitioning mode coded CU.

If the motion field is part of partition 0 (white part of FIG. 2) or 1 (black part of FIG. 2), Mv1 or Mv2 are stored in the corresponding motion field, otherwise if the motion field belongs to the blended part (grey part of FIG. 2), a combined Mv from Mv1 and Mv2 is stored. The combined Mv is generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   Geometric Partitioning Mode (GPM) with Merge Motion Vector Differences (MMVD)

GPM in WVC is extended by applying motion vector refinement on top of the existing GPM uni-directional MVs. A flag is first signaled for a GPM CU, to specify whether this mode is used. If the mode is used, each geometric partition of a GPM CU can further decide whether to signal MVD or not. If MVD is signaled for a geometric partition, after a GPM merge candidate is selected, the motion of the partition is further refined by the signaled MVDs information. All other procedures are kept the same as in GPM.

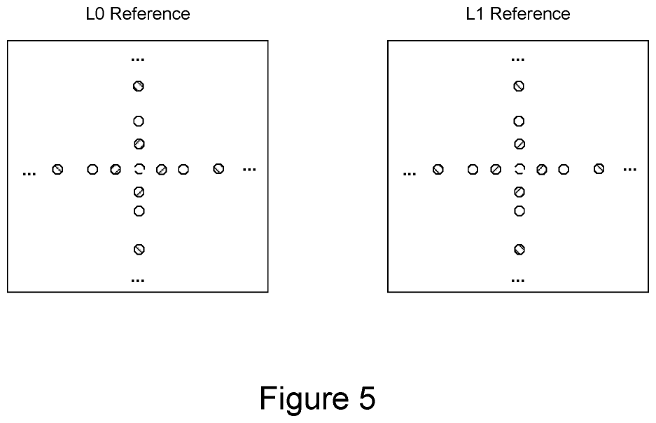

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD) as depicted in FIG. 5. In addition, when pic_fpel_mmvd_enabled_flag is equal to 1, the MVD is left shifted by 2 as in MMVD.

Geometric Partitioning Mode (GPM) with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above, or left and above neighboring samples according to partition angle, as shown in Table 1. The motion is then refined by minimizing the difference between the current template and the template in the reference picture using the same search pattern of merge mode with half-pel interpolation filter disabled.

TABLE 1
Template for the 1st and 2nd geometric partitions, where A represents using above samples,
L represents using left samples, and L+A represents using both left and above samples.

| | Partition angle | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

GPM with Inter and Intra Prediction

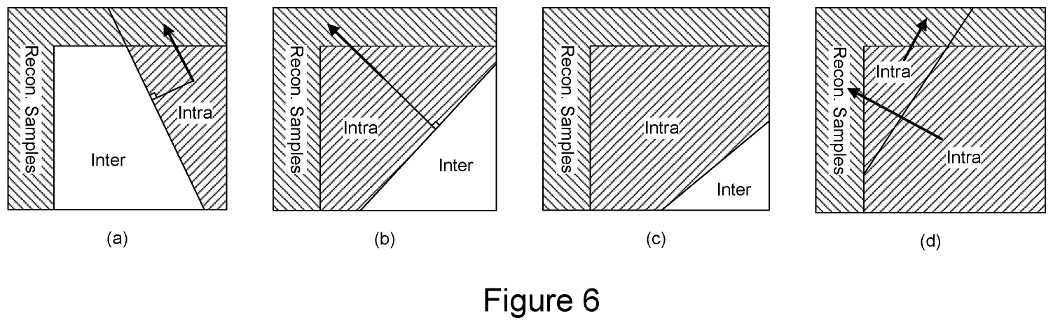

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown in FIG. 6(a)˜(c), respectively. Furthermore, GPM with intra and intra prediction as shown in FIG. 6d is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 2, which are already used for GPM with template matching (GPM-TM).

TABLE 2
The position of available neighboring blocks for IPM candidate derivation based on the angle
of GPM block boundary. A and L denotes the above and left side of the prediction block.

| | Angle of GPM | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighboring blocks.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode is located in the reordering list is signaled.

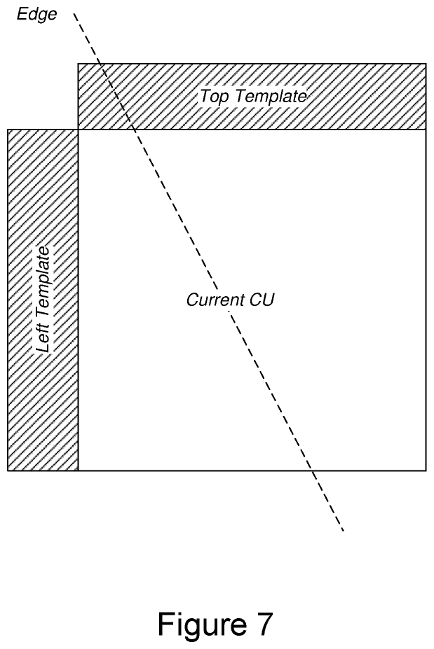

The reordering method for GPM split modes is a two-step process performed after the respective reference templates of the two GPM partitions in a coding unit are generated, as follows:
1. extending GPM partition edge into the reference templates of the two GPM partitions, resulting in 64 reference templates and computing the respective TM cost for each of the 64 reference templates;
2. reordering GPM split modes based on their TM cost values in ascending order and marking the best 32 as available split modes.
   The edge on the template is extended from that of the current CU, as in FIG. 7 illustrates, but GPM blending process is not used in the template area across the edge. After ascending reordering using TM cost, an index is signaled.

In current ECM, GPM can be deduced from a TM method, but it requires the reconstruction of the samples in the template area of the current block, increasing the pipeline latency. Indeed, the decoder should wait for the neighboring blocks to be reconstructed to access the corresponding samples in the TM area.
It is proposed to predict at decoder side the boundary of the GPM.
In one embodiment, the best boundary is predicted and added as a candidate in the list.
In another embodiment, the candidates are ranked according to their boundary fitting score and an index is signaled to select the correct candidate.
In another embodiment, the fitting of the boundary is computed using a metric along the boundary sub-block
In another embodiment, the fitting of the boundary is computed using a metric outside the boundary area.
In another embodiment, mitigate possible latency issue for motion vector predictors

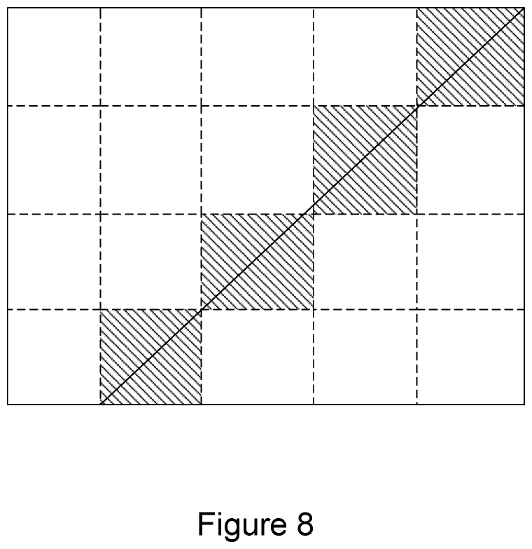

In FIG. 8, we show a GPM coded CU with the split and the subblocks containing the split in grey.

The top and bottom part of the CU are using 2 different motion compensated or intra predictions.

### Cost Computation

In a first embodiment, the cost D of a boundary candidate is computed as the difference between the 2 predictions in the subblocks containing the boundary.

$$Ds = {\sum }_{b ∈ samples in boundary subblocks} \vert P0 ( b ) - P 1 ( b ) \vert$$

Where P0 and P1 are the predictions of list L0 and L1 respectively.
The difference can be computed as: the absolute difference between samples, the square of the difference between samples, the SATD (Sum of Absolute Transformed difference), typically used for prediction evaluation in encoder, or other appropriate metric relating to the difference between samples.

In an embodiment, the cost is computed as the difference between subblocks, outside the subblocks of boundaries. In this case, a negative sign is added to the metric: a larger difference is considered as “better” for the metric.

$$D t = - {\sum }_{b ∉ samples in boundary subblocks} \vert P0 ( b ) - P 1 ( b ) \vert$$

In another embodiment, a mix of the 2 metrics is proposed:

$$D = D s + D t$$

In another embodiment, a weighted sum of the 2 metrics is proposed:

$$D = {\sum }_{b ∈ samples in subblocks} w ( b ) \vert P0 ( b ) - P 1 ( b ) \vert$$

Where w(b) is a weighting factor on each sample.

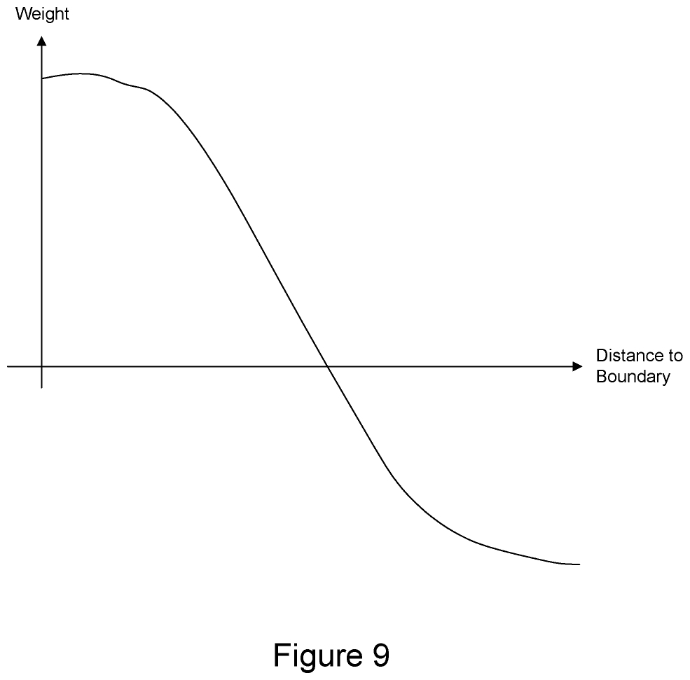

FIG. 9 shows an example of samples weighting: the further a sample is from the boundary, the lower the weight. When close to the boundary, similar samples are giving better score and far from the boundary, not similar samples, are giving better score. In an embodiment, in order to reduce the complexity, the metric is subsampled every N samples horizontally and vertically. Typically, N=2 to subsample every other samples.

### Candidate Selection

All GPM split modes are reordered in ascending ordering based on the D cost values. Instead of sending GPM split mode, an index to indicate where the exact GPM split mode is located in the reordering list is signaled.

In a first embodiment, the cost of each split mode is performed after the list of candidates has been created. Prediction parameters for each part of the block are known: motion vectors mv0 and mv1 and the reference frames R0 and R1. The N best scores for the split mode are computed for each candidate in the list.

An example is shown for N=2 in the table below.

| Index | Candidate | Boundary position, angle | Score D |
|---|---|---|---|
| 0 | 0 | dist = 2, phi = 30 | 300 |
| 1 | 0 | dist = 3, phi = 45 | 350 |
| 2 | 1 | dist = 1, phi = 20 | 200 |
| 3 | 1 | dist = 3, phi = 40 | 450 |
| 4 | . . . | . . . | . . . |

The index is then signaled in the bitstream to specify the final candidate in the list.

In an embodiment, the index of the candidate is first signaled, then the index of the split mode is signaled as shown in the table below, where candidate c has been first signaled:

| Index | Candidate | Boundary position, angle | Score D |
|---|---|---|---|
| 0 | c | dist = 2, phi = 30 | 300 |
| 1 | c | dist = 3, phi = 45 | 350 |
| 2 | c | dist = 1, phi = 20 | 400 |
| 3 | c | dist = 3, phi = 40 | 450 |
| 4 | . . . | . . . | . . . |

In another embodiment, all candidates and all split modes are ranked according to their score D and an index is transmitted to select the best candidate, as shown in the table below:

| Index | Candidate | Boundary position, angle | Score D |
|---|---|---|---|
| 0 | 2 | dist = 2, phi = 30 | 150 |
| 1 | 1 | dist = 3, phi = 45 | 250 |
| 2 | 2 | dist = 1, phi = 20 | 300 |
| 3 | 0 | dist = 3, phi = 40 | 450 |
| 4 | . . . | . . . | . . . |

In an embodiment, the N best candidates according to score D are inserted in the default list (and removed from their former position in the list). For example, the first 2 candidates are the ones found using the above process, but the rest of the list is kept unchanged.

### Alternative Differential Signaling

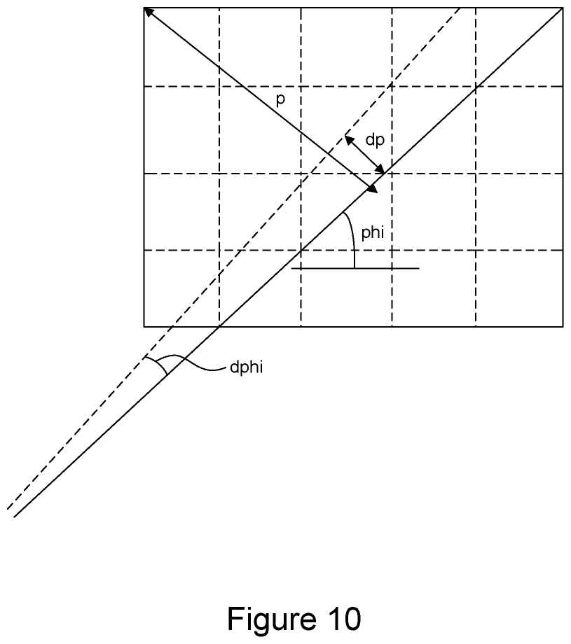

In an embodiment, the score D is used to select the best boundary position for each candidate. This position is then used as the reference to transmit the difference with the final boundary position. In FIG. 10, we show an example of differential signaling of the boundary position: The best boundary position p and orientation phi is found using the previously described ranking method. An additional offset dp on top of p and dphi on top of phi are signaled to get the final position and orientation.

### Estimating the Best Boundary

In an embodiment, that can be combined with any of previous embodiments, one may estimate the most probable boundary using the D cost variation respectively with (θ, ρ). For a given pair of MV candidate, the most probable boundary is estimated as follows:

$$( θ , ρ ) = {argmax}_{( θ , ρ )} ( \frac{δ {D}^{2}}{δθ} + \frac{δ {D}^{2}}{δρ} )$$

### Motion Vector Predictors Propagation

As the computation of the boundary position might introduce some latency in the decoding of the motion information of the block (especially if the motion information should be available for neighboring blocks).

In an embodiment, we propose to propagate the motion information for neighboring blocks “as if” the whole block was a bi-prediction block without a boundary. The rule described in the section on Motion field storage for geometric partitioning mode is applied to deduce the motion information for each subblock.

After the frame has been decoded, all motion information can be made available for temporal prediction and default GPM motion information storage taking into account the boundary position can be applied for the final storage.

### Intra Inter Mode

In case of intra inter mode, or intra-intra mode, both predictions are performed (intra reference samples propagation and inter motion compensation) but only in the sub-blocks in the boundary. The cost computation is also restricted to the subblock in the boundary area.

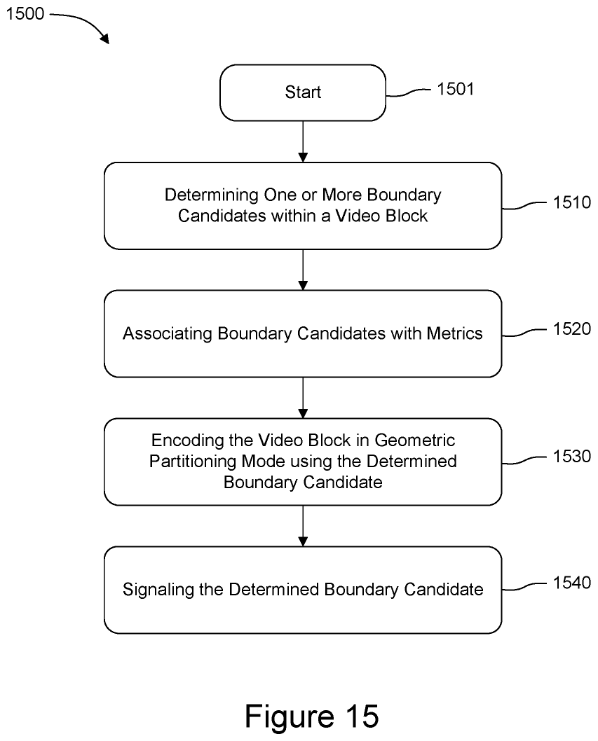

One embodiment of a method 1500 under the general aspects described here is shown in FIG. 15. The method commences at start block 1501 and control proceeds to block 1510 for determining one or more boundary candidates within a video block that uses geometric partitioning mode. Control proceeds from block 1510 to block 1520 for associating the one or more boundary candidates with metrics to determine which boundary candidate to use for encoding. Control proceeds from block 1520 to block 1530 for encoding said video block in geometric partitioning mode using the determined boundary candidate and prediction modes corresponding to portions of the video block defined by the determined boundary candidate. Control proceeds from block 1530 to block 1540 for signaling the determined boundary candidate used in geometric partitioning mode.

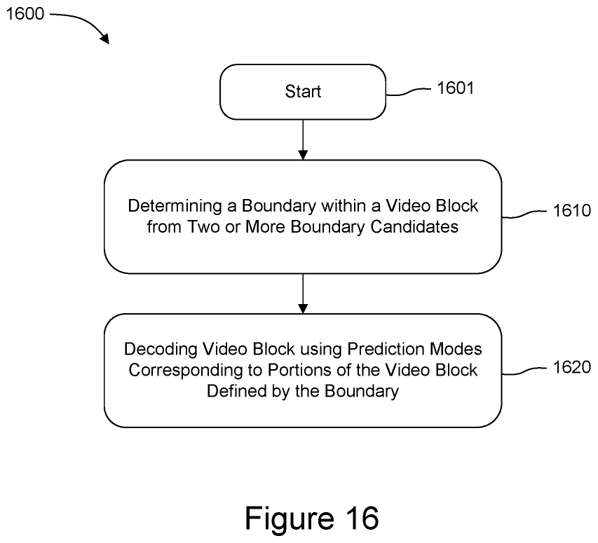

One embodiment of a method 1600 under the general aspects described here is shown in FIG. 16. The method commences at start block 1601 and control proceeds to block 1610 for determining a boundary within a video block that uses geometric partitioning mode from a list of two or more boundary candidates. Control proceeds from block 1610 to block 1620 for decoding said video block using prediction modes corresponding to portions of the video block defined by the boundary.

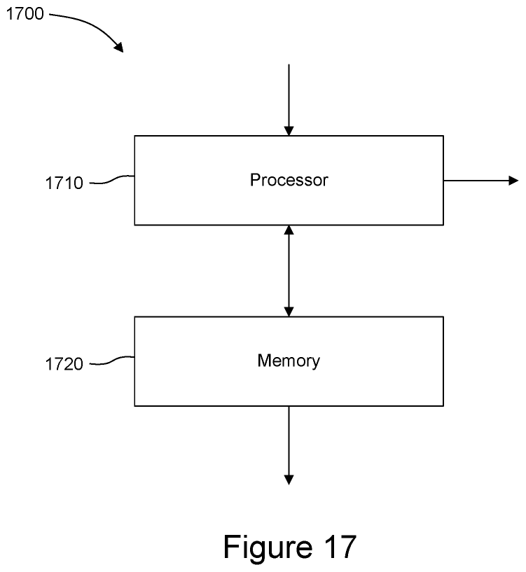

FIG. 17 shows one embodiment of an apparatus 1700 for encoding, decoding, compressing or decompressing video data using prediction of at least one boundary for geometric partitioning mode. The apparatus comprises Processor 1710 and can be interconnected to a memory 1720 through at least one port. Both Processor 1710 and memory 1720 can also have one or more additional interconnections to external connections.

Processor 1710 is also configured to either insert or receive information in a bitstream and, either compressing, encoding or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

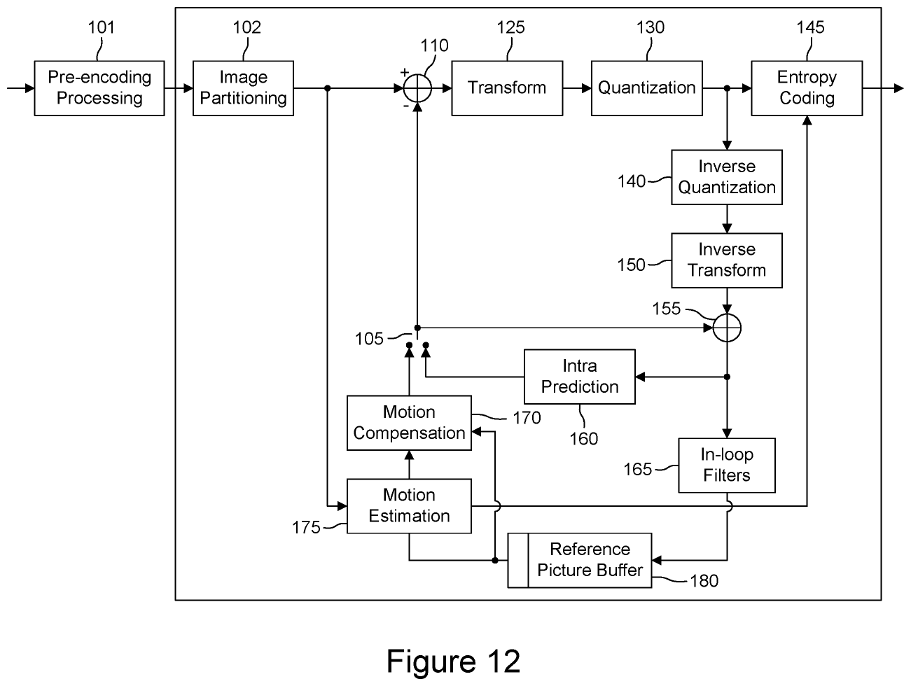

The aspects described and contemplated in this application can be implemented in many different forms. FIGS. 12, 13, and 14 provide some embodiments, but other embodiments are contemplated and the discussion of FIGS. 12, 13, and 14 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

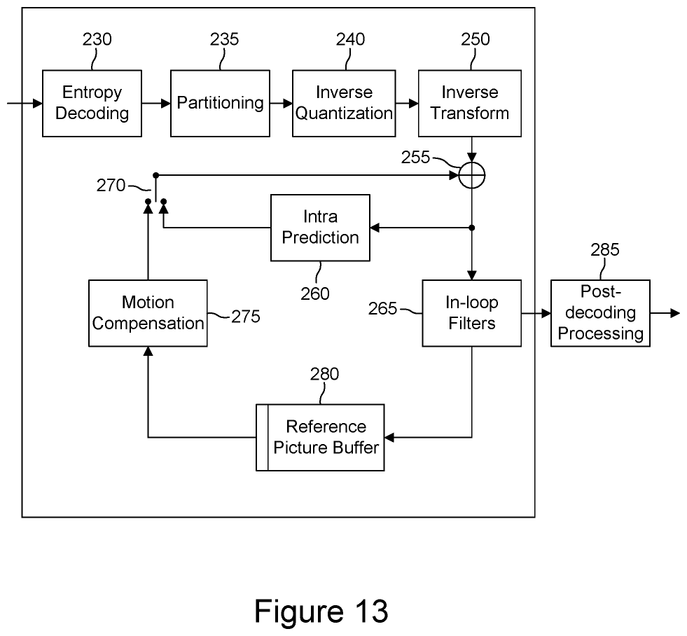

Various methods and other aspects described in this application can be used to modify modules, for example, the intra prediction, entropy coding, and/or decoding modules (160, 360, 145, 330), of a video encoder 100 and decoder 200 as shown in FIG. 12 and FIG. 13. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 12 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 13 illustrates a block diagram of a video decoder 200. In the decoder 200, a bitstream is decoded by the decoder elements as described below. Video decoder 200 generally performs a decoding pass reciprocal to the encoding pass as described in FIG. 12. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

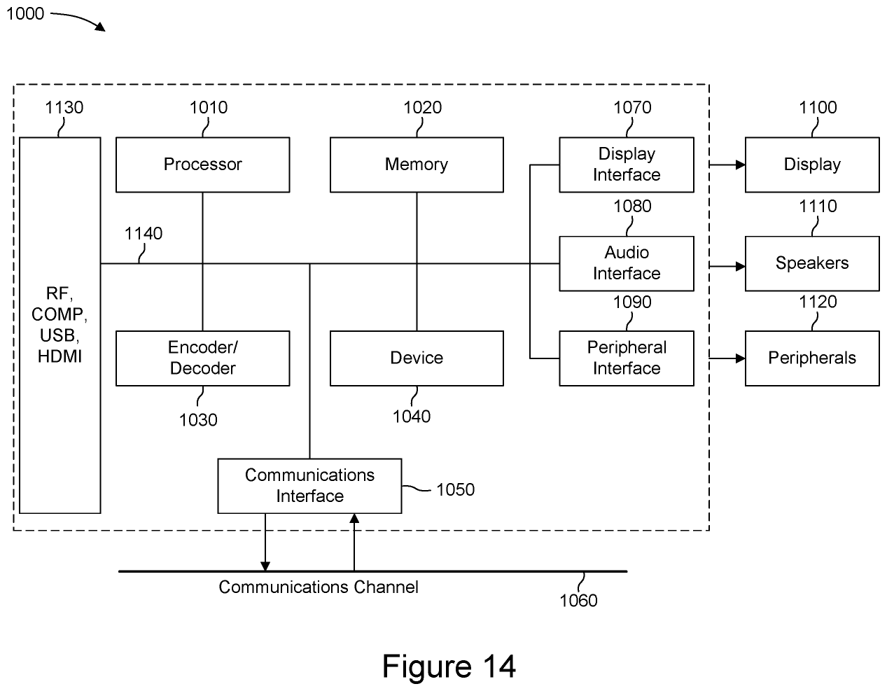

FIG. 14 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 14, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

At least one embodiment comprises predicting a boundary for a video block or sub-block.

At least one embodiment comprises the above prediction using a cost estimate.

At least one embodiment comprises associating a metric to each boundary predicted.

At least one embodiment comprises adding predicted boundary locations to a list.

At least one embodiment comprises the above list based on a metric.

At least one embodiment comprises the above metric based on an error or difference.

At least one embodiment comprises including signaling in video data or a bitstream indicative of a boundary to use for geometric partitioning mode coding.

At least one embodiment comprises any decoding operation based on the above operations.

At least one embodiment comprises a bitstream or signal that includes one or more of the described syntax elements, or variations thereof.

At least one embodiment comprises a bitstream or signal that includes syntax conveying information generated according to any of the embodiments described.

At least one embodiment comprises creating and/or transmitting and/or receiving and/or decoding according to any of the embodiments described.

At least one embodiment comprises a method, process, apparatus, medium storing instructions, medium storing data, or signal according to any of the embodiments described.

At least one embodiment comprises inserting in the signaling syntax elements that enable the decoder to determine decoding information in a manner corresponding to that used by an encoder.

At least one embodiment comprises creating and/or transmitting and/or receiving and/or decoding a bitstream or signal that includes one or more of the described syntax elements, or variations thereof.

At least one embodiment comprises a TV, set-top box, cell phone, tablet, or other electronic device that performs transform method(s) according to any of the embodiments described.

At least one embodiment comprises a TV, set-top box, cell phone, tablet, or other electronic device that performs transform method(s) determination according to any of the embodiments described, and that displays (e.g., using a monitor, screen, or other type of display) a resulting image.

At least one embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

At least one embodiment comprises a TV, set-top box, cell phone, tablet, or other electronic device that receives (e.g., using an antenna) a signal over the air that includes an encoded image, and performs transform method(s).

1. A method, comprising:
determining one or more boundary candidates within a video block that uses geometric partitioning mode;
associating the one or more boundary candidates with metrics to determine which boundary candidate to use for encoding;
encoding said video block in geometric partitioning mode using the determined boundary candidate and prediction modes corresponding to portions of the video block defined by the determined boundary candidate; and,
signaling the determined boundary candidate used in geometric partitioning mode.

2. An apparatus, comprising:
a processor, configured to perform:
determining one or more boundary candidates within a video block that uses geometric partitioning mode;
associating the one or more boundary candidates with metrics to determine which boundary candidate to use for encoding;
encoding said video block in geometric partitioning mode using the determined boundary candidate and prediction modes corresponding to portions of the video block defined by the determined boundary candidate; and,
signaling the determined boundary candidate used in geometric partitioning mode.

3. A method, comprising:
determining a boundary within a video block that uses geometric partitioning mode from a list of two or more boundary candidates; and,
decoding said video block using prediction modes corresponding to portions of the video block defined by the boundary.

4. An apparatus, comprising:
a processor, configured to perform:
determining a boundary within a video block that uses geometric partitioning mode from a list of two or more boundary candidates; and,
decoding said video block using prediction modes corresponding to portions of the video block defined by the boundary.

5. The method of claim 1, wherein determining comprises a cost determination.

6. The method of claim 1, wherein the boundary candidate used for encoding is determined through error analysis.

7. The method of claim 3, wherein the boundary is determined by using an index indicative of one of several boundary candidates to be used.

8. The method of claim 1, wherein the boundary candidates are ranked according to a boundary fitting score.

9. The apparatus of claim 2, wherein the boundary candidates are associated with metrics outside a boundary area.

10. The apparatus of claim 2, wherein a cost of a boundary candidate is determined as an absolute difference between two predictions in blocks containing the boundary candidate.

11. The apparatus of claim 2, wherein a boundary score is used as a reference boundary location and a difference is signaled to indicate a final boundary position.

12. A device comprising:
an apparatus according to claim 1; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 1.

16. The method of claim 3, wherein determining comprises a cost determination.

17. The method of claim 3, wherein the boundary candidate used for encoding is determined through error analysis.

18. The method of claim 17, wherein the boundary is determined by using an index indicative of one of several boundary candidates to be used.

19. The apparatus of claim 4, wherein the boundary candidates are ranked according to a boundary fitting score.

20. The apparatus of claim 4, wherein the boundary candidates are associated with metrics outside a boundary area.

21. The apparatus of claim 4, wherein a boundary score is used as a reference boundary location and a difference is signaled to indicate a final boundary position.
